(19) United States
(12) Patent Application Publication
(10) Pub. No.: US 2025/0224610 A1
(43) Pub. Date: Jul. 10, 2025

(54) MINIATURIZED OPTICAL DEVICE AND OPTICAL LENS SYSTEM

(71) Applicant: MEGAFORCE COMPANY LIMITED, NEW TAIPEI CITY (TW)

(72) Inventors: Yuh-Hom Tseng, NEW TAIPEI CITY (TW); SHI-CHENG LAI, NEW TAIPEI CITY (TW); CHUNG-YU WEI, NEW TAIPEI CITY (TW)

(21) Appl. No.: 18/980,682

(22) Filed: Dec. 13, 2024

Related U.S. Application Data
(60) Provisional application No. 63/610,707, filed on Dec. 15, 2023.

(30) Foreign Application Priority Data
Dec. 4, 2024 (TW) 113146884

(51) Int. Cl. G02B 27/01; G02B 9/12; G02B 13/00; G02B 27/28; G03B 21/00; G03B 21/20

(52) U.S. Cl. CPC G02B 27/0172; G02B 9/12; G02B 13/0035; G02B 13/006; G02B 13/0065; G02B 27/283; G03B 21/006; G03B 21/2033; G02B 2027/0178

(57) ABSTRACT

A miniaturized optical device and an optical lens system are provided. The miniaturized optical device includes a light source, an optical film, a beam splitter, a liquid crystal on silicon (LCOS) module, and an optical lens group. The light source provides an initial incident light along a first optical path. The optical film generates a first incident light with a first polarization direction. The beam splitter receives the first incident light from the polarization element, and generates a first reflected light along a first optical path. The LCOS module is configured to, upon receiving the first reflected light with a first polarization direction, generate a second incident light with a second polarization direction along the second optical path and passing through the beam splitter. The optical lens group is collimated to the LCOS module and configured to focus the second incident light to generate an outgoing light.

### CROSS-REFERENCE TO RELATED PATENT APPLICATION

This application claims the benefit of priority to Taiwan Patent Application No. 113146884, filed on Dec. 4, 2024. The entire content of the above identified application is incorporated herein by reference.

This application claims the benefit of priority to the U.S. Provisional Patent Application Ser. No. 63/610,707, filed on Dec. 15, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical device and system, and more particularly to a miniaturized optical device and an optical lens system.

### BACKGROUND OF THE DISCLOSURE

Liquid crystal on silicon (LCOS) is a display technology that leverages a liquid crystal layer and a silicon substrate to control the reflection and transmission of light. Renowned for their ability to deliver superior image quality and high resolution, LCOS displays are widely utilized in high-definition projection systems and wearable displays, such as augmented reality (AR) glasses.

In AR glasses, an optical engine is a critical component responsible for projecting digital images into the user's field of view. Currently, optical engines employing LCOS technology have a volume of approximately 4 cubic centimeters or more. Existing designs require light to traverse five distinct paths for achieving the final visual effects. The light source, typically an LED or laser, emits light, which travels through the first path into a polarization beam splitter. The polarization beam splitter divides the light into two beams with different polarization orientations. One beam is directed toward a reflective mirror, forming the second path. The light is reflected off the mirror and enters the LCOS display module, constituting the third path. The LCOS display module modulates the light's phase and intensity based on the intended display content. In the fourth path, the modulated light passes through the polarization beam splitter again, where the beams are recombined. Finally, in the fifth path, the recombined light travels through a projection lens or optical system and is projected into the user's field of view.

While this configuration enables high-resolution and high-contrast display performance, the necessity for multiple reflections and refractions leads to significant light loss, which can adversely impact overall optical efficiency.

As a consequence of the challenges in balancing image quality and optical efficiency faced by current compact LCOS optical engines, there is a need for innovations in optical path designs and structural enhancements such that the optical engine's volume can be reduced.

### SUMMARY OF THE DISCLOSURE

In response to the above-referenced technical inadequacies, the present disclosure provides a miniaturized optical device and an optical lens system capable of reducing the volume of LCOS optical engines, thereby meeting the miniaturization requirements of wearable devices, such as AR glasses.

In order to solve the above technical problems, one of the technical solutions adopted by the present disclosure is to provide a miniaturized optical device, which includes a light source, an optical film, a beam splitter, a liquid crystal on silicon (LCOS) module, and an optical lens group. The light source provides an initial incident light along a first optical path. The optical film is disposed on the first optical path, and is configured to generate a first incident light with a first polarization direction. The beam splitter is disposed on the first optical path, and is configured to receive the first incident light from the optical film and generate a first reflected light along a second optical path. The LCOS module is configured to, upon receiving the first reflected light with a first polarization direction, generate a second incident light with a second polarization direction along the second optical path, and allow the second incident light to pass through the beam splitter. The optical lens group is collimated to the LCOS module along the second optical path, and the optical lens group is configured to focus the second incident light from the beam splitter to generate an outgoing light.

In order to solve the above technical problems, one of the technical solutions adopted by the present disclosure is to provide an optical lens system, which sequentially includes a cemented lens and a light-receiving lens along an optical axis from a light-receiving side to a light-emitting side. The light-receiving lens has negative refractive power, and the cemented lens includes at least two materials with different refractive indices and has positive refractive power.

In order to solve the above technical problems, one of the technical solutions adopted by the present disclosure is to provide a miniaturized optical device, which includes an LCOS module and an optical lens group. The LCOS module is configured to generate a primary incident light. The optical lens group has a folded optical path architecture, and is used to focus the primary incident light to produce an outgoing light. The optical lens group sequentially includes a first lens, a second lens, and a third lens from a light-receiving side to a light-emitting side.

Therefore, the miniaturized optical device provided by the present disclosure achieves a reduction in the volume of an LCOS optical engine through an innovative optical path design, which allows the optical engine to meet the miniaturization requirements of optical engines for wearable devices (not limited to AR glasses). In particular, the number of optical paths in the LCOS module can be reduced to three, thereby minimizing refraction losses caused by light transmission and reflection. With a simplified optical path, efficiency losses are reduced, enabling the collimation of the optical path through the lenses while retaining room for further improvement. Additionally, the design can be adapted to meet various requirements, making it compatible with different optical lens groups and facilitating modularity.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a structural schematic diagram of a miniaturized optical device according to one embodiment of the present disclosure;

FIG. 2 is a structural schematic diagram of an optical film according to one embodiment of the present disclosure;

FIG. 3 is a structural schematic diagram of an optical lens group according to one embodiment of the present disclosure;

FIG. 4 is a simulation diagram showing optical paths of the optical lens group of FIG. 3;

FIG. 5 is a graph illustrating a modulation transfer function (MTF) curve of the miniaturized optical device in one embodiment of the present disclosure;

FIG. 6 is a structural schematic diagram of the miniaturized optical device according to one embodiment of the present disclosure;

FIG. 7 is a structural schematic diagram of an optical lens group according to one embodiment of the present disclosure; and

FIG. 8 is a simulation diagram showing optical paths of the optical lens group according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

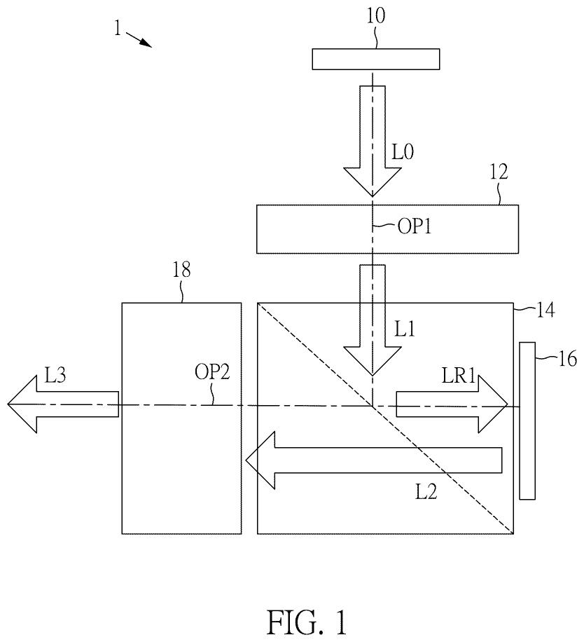

FIG. 1 is a structural schematic diagram of a miniaturized optical device according to one embodiment of the present disclosure. Referring to FIG. 1, one embodiment of the present disclosure provides a miniaturized optical device 1, which includes a light source 10, an optical film 12, a beam splitter 14, a liquid crystal on silicon (LCOS) module 16, and an optical lens group 18.

The light source 10 provides initial incident light L0 along a first optical path OP1. The light source 10 can be, for example, a light-emitting diode (LED) or a laser diode.

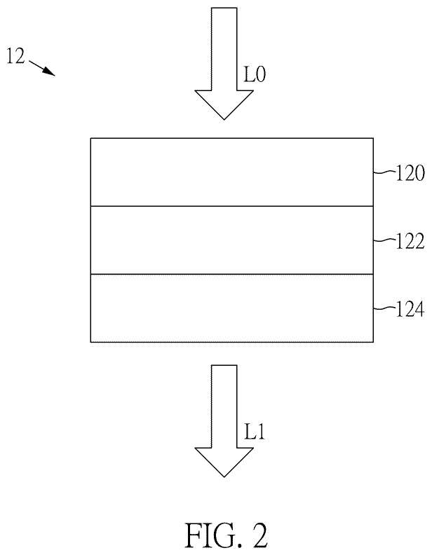

FIG. 2 is a structural schematic diagram of an optical film according to one embodiment of the present disclosure. Referring to FIG. 2, in the embodiment of the present disclosure, the optical film 12 sequentially includes a diffusion film 120, a brightness enhancement film 122, and a polarization element 124 from the light-receiving side to the light-emitting side. The light source 10 is positioned on the light-receiving side relative to the optical film 12, while the beam splitter 14 is positioned on the light-emitting side relative to the optical film 12.

Since the initial incident light LO has a certain degree of divergence, the optical film 12 can be placed along the first optical path OP1 to collect the divergent light and generate first incident light L1 with a first polarization direction. Through the stacking of specialized film materials, the intensity of the first incident light L1 entering the beam splitter 14 can be enhanced (i.e., increasing brightness), thereby improving conversion efficiency. For example, the final outgoing brightness of the miniaturized optical device 1 can be greater than 2 lumens (lm). This design eliminates the need for conventional light guide bars that utilize light guide channels, CPC concentrators, collimation lenses, and reflective light guide elements with geometric reflective surfaces, thereby reducing overall volume.

Specifically, the diffusion film 120 can be used to enhance the uniformity of the initial incident light L0. The brightness enhancement film is a dual brightness enhancement film (DBEF) that collects the reflected light generated by the initial incident light L0 and facilitates multiple transmissions and reflections within it, thereby increasing the brightness of the first incident light L1. The polarization element 124 can, for example, be a wire grid polarizing film (WGF), which polarizes the initial incident light L0 into the first incident light L1 with a first polarization direction.

The beam splitter 14, which can, for instance, be a polarization beam splitter, is positioned along the first optical path OP1. The beam splitter 14 is typically composed of multilayer dielectric films or prism assemblies and is capable of splitting light based on a polarization state of the light inputted thereto. The beam splitter 14 can be designed to reflect the incident light with a first polarization direction while transmitting the incident light with a second polarization direction. Thus, when the beam splitter 14 receives the first incident light L1 from the optical film 12, the beam splitter 14 can generate a first reflected light LR1 along a second optical path OP2.

The LCOS module 16 can include a liquid crystal layer, a reflective layer (such as a silicon substrate), and a driving circuit. The liquid crystal layer changes its molecular alignment under an applied voltage, thereby altering the polarization state of the light. Specifically, upon the LCOS module 16 receiving the first reflected light LR1 with the first polarization direction, the first reflected light LR1 enters the liquid crystal layer, and the molecular alignment of the liquid crystal layer changes due to the applied voltage. The polarization state of the reflected light LR1 is changed from the first polarization direction to the second polarization direction, and the reflected light LR1 with the second polarization direction is reflected by the reflective layer. Afterward, a second incident light L2 with the second polarization direction along the second optical path OP2 is generated by the LCOS module 16 and then enters the beam splitter 14. When the beam splitter 14 receives the second incident light L2 from the LCOS module 16, the second incident light L2 is transmitted through the beam splitter 14 and enters the optical lens group 18.

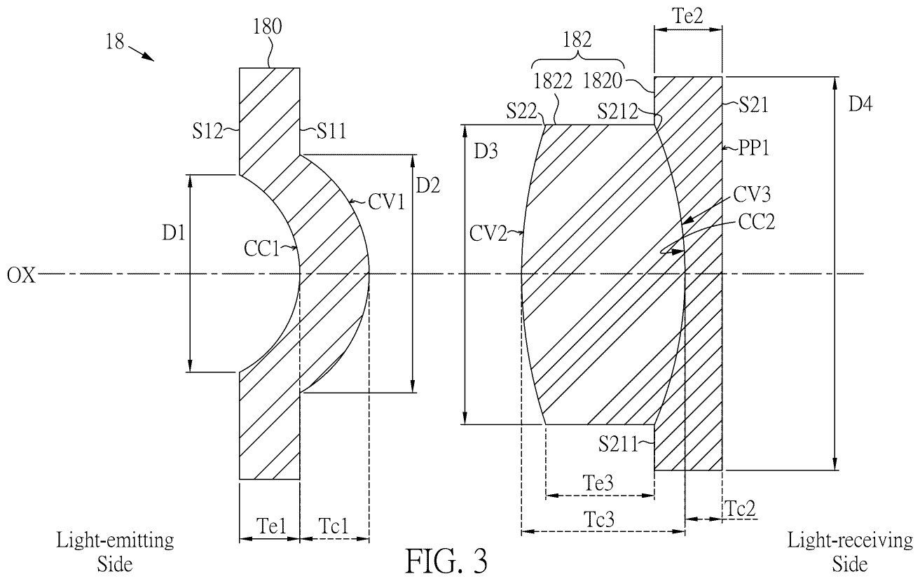

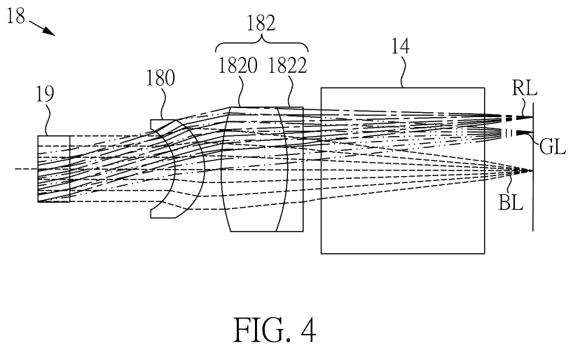

The optical lens group 18, as part of the optical lens system provided in this embodiment, is aligned with the LCOS module 16 along the second optical path OP2. The optical lens group 18 is used to focus the second incident light L2 from the beam splitter 14 to produce an outgoing light L3. FIG. 3 is a structural schematic diagram of an optical lens group according to one embodiment of the present disclosure. Referring to FIG. 3, the optical lens group 18 includes, in sequence along the optical axis OX from the light-receiving side to the light-emitting side, a cemented lens 182 and a light-receiving lens 180. In the optical design of the present embodiment, the light-receiving lens 180 is a concave lens with negative refractive power. In a preferred embodiment, the negative refractive power of the light-receiving lens 180 can range from 0.01 to 0.015. Additionally, reference is made to FIG. 4, which is a simulation diagram showing optical paths of the optical lens group of FIG. 3. As depicted in FIG. 4, the cemented lens 182 includes at least two materials with different refractive indices and has positive refractive power. Considering the influence of the beam splitter 14, lights of different wavelengths (e.g., red light RL, green light GL, and blue light BL) emitted from the same plane passes through the cemented lens 182 and the light-receiving lens 180, and the lights can be completely collected by an intermediate component 19, which can, for example, be a planar lens formed during a modularization process of the optical lens group 18. When the miniaturized optical device 1 of the present disclosure is applied to augmented reality (AR) glasses, the outgoing light L3 produced by the optical lens group 18 can enter a holographic optical element (HOE). The HOE, as a core component of the AR glasses, is responsible for functions such as splitting, combining, reflecting, or transmitting light beams. HOEs are typically made of multilayer dielectric films or optical materials and are capable of performing optical modulation based on design requirements. The light beams processed by the HOE is then transmitted to the user's eyes.

Furthermore, in this embodiment, the light-receiving lens 180 has a light-receiving side surface S11 facing the light-receiving side and a light-emitting side surface S12 facing the light-emitting side. The cemented lens 182 has a light-receiving side surface S21 facing the light-receiving side and a light-emitting side surface S22 facing the light-emitting side. The light-receiving side surface S11 of the light-receiving lens 180 is provided with a convex portion CV1, and the light-emitting side surface S12 of the light-receiving lens 180 has a concave portion CC1 adjacent to the optical axis OX. The light-receiving side surface S21 of the cemented lens 182 includes a planar portion PPI, and the light-emitting side surface S22 of the cemented lens 182 is provided with a convex portion CV2.

From a dimensional perspective, a diameter D1 of the concave portion CC1 is smaller than a diameter D2 of the convex portion CV1, a curvature of the concave portion CC1 is greater than a curvature of the convex portion CV1, and a central thickness Tc1 of the light-receiving lens 180 is greater than an edge thickness Te1 of the light-receiving lens 180. The central thickness Tc1 of the light-receiving lens 180 can range from 2 to 5 mm, and the edge thickness Te1 can range from 1 to 4 mm. Moreover, a diameter D1 of the concave portion CC1 can range from 4 to 6 mm, a diameter D2 of the convex portion CV1 can range from 6 to 8 mm, a radius of curvature of the concave portion CC1 and a radius of curvature of the convex portion CV1 can range from 2 to 5 mm.

On the other hand, the cemented lens 182 includes, in sequence along the optical axis OX from the light-receiving side to the light-emitting side, a first lens 1820 and a second lens 1822 that are bonded together. The first lens 1820 can be a concave lens with negative refractive power, while the second lens 1822 can be a convex lens with positive refractive power. A material forming the second lens 1822 has a refractive index lower than that of the material forming the first lens 1820 and the light-receiving lens 180. For example, the second lens 1822 can be made of plastic, and the light-receiving lens 180 and the first lens 1820 can be made of glass. Additionally, the refractive indices of the materials forming the first lens 1820 and the light-receiving lens 180 are also different.

The first lens 1820 has a light-receiving side surface (i.e., the light-receiving side surface S21) and a light-emitting side surface S211. The second lens 1822 has a light-receiving side surface S212 and a light-emitting side surface (i.e., the light-emitting side surface S22). The light-receiving side surface (S21) of the first lens 1820 is provided with a planar portion PP1, the light-emitting side surface S211 of the first lens 1820 is provided with a concave portion CC2, the light-receiving side surface S212 of the second lens 1822 is provided with a convex portion CV3 complementary in shape to the concave portion CC2, and the light-emitting side surface (S22) of the second lens 1822 is provided with the convex portion CV2.

A diameter D3 of the convex portion CV2 is equal to diameters of the convex portion CV3 and the concave portion CC2, and can range from 5 to 8 mm. A radius of curvature of the convex portion CV2 is greater than that of the convex portion CV3, and a central thickness Tc3 of the second lens 1822 is greater than an edge thickness Te3 of the second lens 1822. The central thickness Tc3 and the edge thickness Te3 of the second lens 1822 can range from 0.5 to 2 mm. Furthermore, in this embodiment, the diameter D3 of the concave portion CC2 is smaller than the diameter D4 of the planar portion PP1. The diameter D4 of the planar portion PP1 can range from 8 to 11 mm. The central thickness Tc2 of the first lens 1820 is smaller than the edge thickness Te2 of the first lens 1820. The central thickness Tc2 can range from 1 to 4 mm, while the edge thickness Te2 can range from 3 to 6 mm.

Thus, through the stacking arrangement of the first lens 1820, the second lens 1822, and the light-receiving lens 180, combined with a refractive index progression that transitions from large to small and then back to large, the lights of different wavelengths (e.g., red light RL, green light GL, and blue light BL) emitted from the same plane can pass through the cemented lens 182, then through the light-receiving lens 180, and be fully collected in the intermediate component 19.

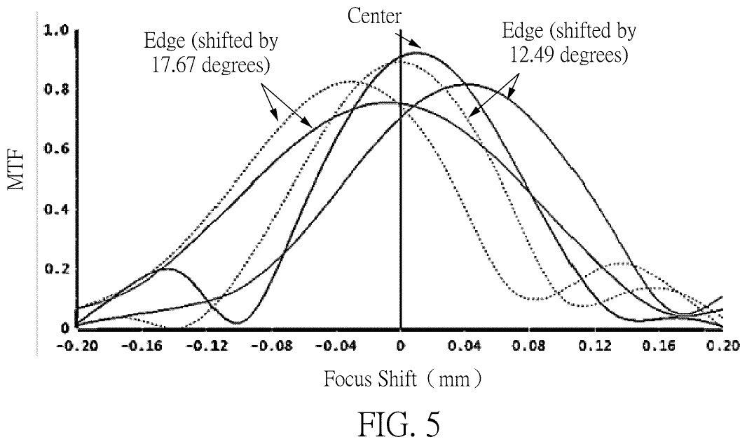

Referring to FIG. 5, FIG. 5 is a graph illustrating a modulation transfer function (MTF) curve of the miniaturized optical device in one embodiment of the present disclosure. The MTF can be utilized to describe an optical imaging quality of a lens in terms of resolution and sharpness. As shown in FIG. 5, at a spatial frequency of 28 line pairs per millimeter (lp/mm), the MTF at the center exceeds 0.8, while the MTF at the edges exceeds 0.6. Additionally, the field of view (FOV) can be greater than or equal to 35 degrees.

In the miniaturized optical device 1 provided by the above embodiment, an innovative optical path design is used to reduce the volume of the LCOS optical engine, so as to meet the miniaturization requirements of wearable devices such as AR glasses. Specifically, the number of optical paths in the LCOS module 16 can be reduced to three, thereby minimizing refraction losses caused by light transmission and reflection. The simplified optical path, combined with the use of the optical film 12, further reduces efficiency losses, enables collimation of the optical path through the lenses, and leaves room for optimization. Additionally, the LCOS module 16 allows for adaptation to various requirements, making it compatible with different optical lens groups 18 and facilitating easier modularization.

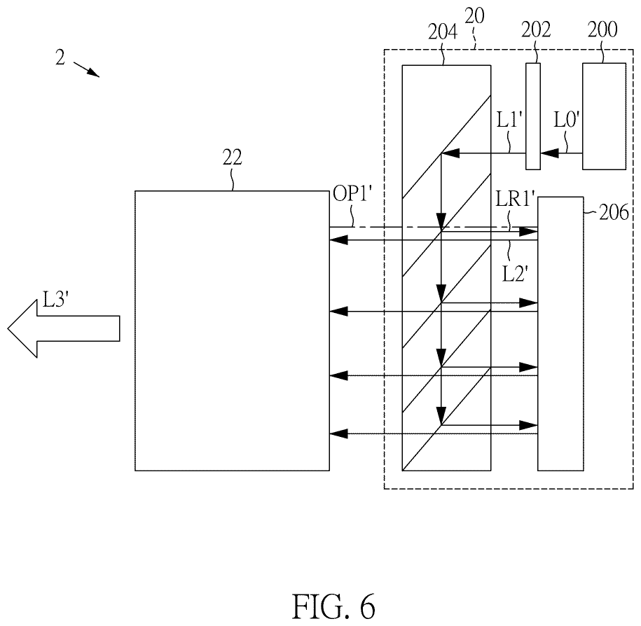

FIG. 6 is a structural schematic diagram of the miniaturized optical device according to another one embodiment of the present disclosure. Referring to FIG. 6, another embodiment of the present disclosure provides a miniaturized optical device 2, which includes an LCOS module 20 and an optical lens group 22. The LCOS module 20 is configured to generate primary incident light. The LCOS module 20 can, for example, be a reflective LCOS module and includes a light source 200, a polarization element 202, a beam splitter 204, an LCOS panel 206, and the optical lens group 22. The light source 200 can, for instance, be a light-emitting diode (LED), which provides initial incident light L0′.

The polarization element 202 is used to receive the initial incident light L0′ and generate a first incident light L1′ with a first polarization direction. The beam splitter 204 can be a transflective mirror with a multilayer structure. The beam splitter 204 receives the first incident light L1′ from the polarization element 202 and generates first reflected light LR1′ along the first optical path OP1′. The LCOS panel 206 is configured to generate a primary incident light L2′ with a second polarization direction along the first optical path OP1′ upon receiving the first reflected light LR1′ with the first polarization direction, and allow the primary incident light L2′ to pass through the beam splitter 204.

The LCOS module 16 can include a liquid crystal layer, a reflective layer (such as a silicon substrate), and a driving circuit. The liquid crystal layer changes its molecular alignment under an applied voltage, thereby altering the polarization state of the light. Specifically, upon receiving the first reflected light LR1′ with the first polarization direction, the first reflected light LR1′ enters the liquid crystal layer, and the liquid crystal molecules align in a specific manner due to the applied voltage, causing the first reflected light LR1′ to change its polarization direction from the first polarization direction to the second polarization direction. The first reflected light LR1′ is then reflected by the reflective layer, and a second incident light L2′ with the second polarization direction is generated and then enters the beam splitter 204.

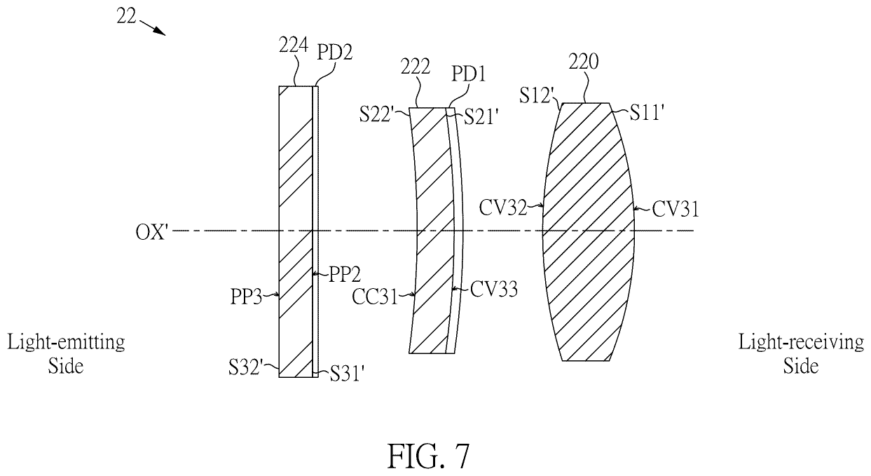

The optical lens group 22 has a folded optical path architecture, which focuses the primary incident light L2′ to produce an outgoing light L3′. Referring to FIG. 7, FIG. 7 is a structural schematic diagram of an optical lens group according to another one embodiment of the present disclosure. The optical lens group 22 includes, in sequence from the light-receiving side to the light-emitting side along the optical axis OX′, a first lens 220, a second lens 222, and a third lens 224.

In this embodiment, the first lens 220 is an aspheric lens, while the second lens 222 and third lens 224 are spherical lenses. The first lens 220 can be, for example, a convex lens with positive refractive power. Both the second lens 222 and the third lens 224 have negative refractive power. Additionally, a material forming the third lens 224 has a refractive index greater than that of a material forming the second lens 222, primarily to enhance imaging quality.

The first lens 220 has a light-receiving side surface S11′ facing the light-receiving side and a light-emitting side surface S12′ facing the light-emitting side. The light-receiving side surface S11′ is provided with a convex portion CV31, and the light-emitting side surface S12′ is provided with a convex portion CV32.

The second lens 222 has a light-receiving side surface S21′ facing the light-receiving side and a light-emitting side surface S22′ facing the light-emitting side. The third lens 224 has a light-receiving side surface S31′ facing the light-receiving side and a light-emitting side surface S32′ facing the light-emitting side. The second lens 222′s light-receiving side surface S21′ is provided with a first phase-delayed element PD1 and a convex portion CV33, while the light-emitting side surface S22′ thereof is provided with a concave portion CC31. The light-receiving side surface S31′ and the light-emitting side surface S32′ of the third lens 224 are provided with planar portions PP2 and PP3, respectively. Additionally, the light-receiving side surface S31′ of the third lens 224 is provided with a second phase-delayed element PD2.

The first phase-delayed element PD1 operates such that after the primary incident light L2′ passes through the first phase-delayed element PD1 to acquire a first delayed phase, the primary incident light L2′ undergoes a first reflection at the second phase-delayed element PD2, returns to the first phase-delayed element PD1 for a second reflection, and then passes through the third lens 224 to form the outgoing light L3′. The first phase-delayed element PD1 and the second phase-delayed element PD2 are both reflecting polarizers and possess characteristics of quarter-wave plates.

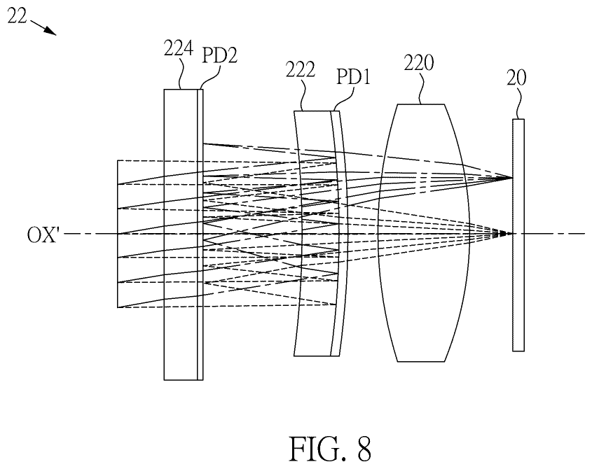

Referring to FIG. 8, FIG. 8 is a simulation diagram showing optical paths of the optical lens group according to another one embodiment of the present disclosure. As shown in FIG. 8, in the folded optical path architecture of the present disclosure, the first lens 220, the second lens 222, and the third lens 224 are combined while performing refractive power adjustment on one of them, and selective reflection and transmission properties of polarized lights are utilized together with the quarter-wave plate's ability to adjust the polarization state of the lights. The lights are reflected back and forth and ultimately transmitted outward. This configuration significantly shortens the effective focal length (EFL), thereby reducing the overall volume of the miniaturized optical device 2. Thus, in terms of compactness, imaging quality, and refractive adjustment, the folded optical path architecture demonstrates improvements compared to optical systems without such architecture.

### Beneficial Effects of the Embodiments

In conclusion, the miniaturized optical device provided by the present disclosure achieves a reduction in the volume of an LCOS optical engine through an innovative optical path design, which allows the optical engine to meet the miniaturization requirements of optical engines for wearable devices (e.g., AR glasses). In particular, the number of optical paths in the LCOS module can be reduced to three, thereby minimizing refraction losses caused by light transmission and reflection. With a simplified optical path, efficiency losses are reduced, enabling the collimation of the optical path through the lenses while retaining room for further improvement. Additionally, the design can be adapted to meet various requirements, making it compatible with different optical lens groups and facilitating modularity.

Furthermore, in the miniaturized optical device and optical lens system provided by the present disclosure, the optical lens group with the folded optical path architecture is utilized. The first lens, the second lens, and the third lens are combined while performing refractive power adjustment on one of them, and selective reflection and transmission properties of polarized lights are utilized together with the quarter-wave plate's ability to adjust the polarization state of the lights. The lights are reflected back and forth and ultimately transmitted outward. This configuration significantly shortens the EFL, thereby reducing the overall volume of the miniaturized optical device. Thus, in terms of compactness, imaging quality, and refractive adjustment, the folded optical path architecture demonstrates improvements compared to optical systems without such architecture.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A miniaturized optical device, comprising:
a light source providing an initial incident light along a first optical path;
an optical film disposed on the first optical path, wherein the optical film is configured to generate a first incident light with a first polarization direction;
a beam splitter disposed on the first optical path, wherein the beam splitter is configured to receive the first incident light from the optical film and generate a first reflected light along a second optical path;
a liquid crystal on silicon (LCOS) module configured to, upon receiving the first reflected light with a first polarization direction, generate a second incident light with a second polarization direction along the second optical path and passing through the beam splitter; and
an optical lens group collimated to the LCOS module along the second optical path, wherein the optical lens group is configured to focus the second incident light from the beam splitter to generate an outgoing light.

2. The miniaturized optical device according to claim 1, wherein the optical lens group sequentially includes a cemented lens and a light-receiving lens along an optical axis from a light-receiving side to a light-emitting side, the light-receiving lens has negative refractive power, and the cemented lens includes at least two materials with different refractive indices and has positive refractive power.

3. The miniaturized optical device according to claim 2, wherein the light-receiving lens and the cemented lens each have a light-receiving side surface facing the light-receiving side and a light-emitting side surface facing the light-emitting side, the light-receiving side surface of the light-receiving lens is provided with a first convex portion, the light-emitting side surface of the light-receiving lens is provided with a first concave portion adjacent to the optical axis, the light-receiving side surface of the cemented lens is provided with a first planar portion, and the light-emitting side surface of the cemented lens is provided with a second convex portion.

4. The miniaturized optical device according to claim 3, wherein a diameter of the first concave portion is smaller than a diameter of the first convex portion, a curvature of the first concave portion is greater than a curvature of the first convex portion, and a central thickness of the light-receiving lens is greater than an edge thickness of the light-receiving lens.

5. The miniaturized optical device according to claim 3, wherein the cemented lens sequentially includes a first lens and a second lens along the optical axis from the light-receiving side to the light-emitting side, the first lens has negative refractive power, and the second lens has positive refractive power.

6. The miniaturized optical device according to claim 5, wherein a material forming the second lens has a refractive index smaller than refractive indices of a material forming the first lens and a material forming the light-receiving lens, and the first lens and the second lens each have a light-receiving side surface facing the light-receiving side and a light-emitting side surface facing the light-emitting side, the light-receiving side surface of the first lens is provided with the first planar portion, a light-emitting side surface of the first lens is provided with a second concave portion, the light-receiving side surface of the second lens is provided with a third convex portion complementary to the second concave portion, and the light-emitting side surface of the second lens is provided with the second convex portion.

7. The miniaturized optical device according to claim 6, wherein a diameter of the second convex portion is equal to a diameter of the third convex portion, a radius of curvature of the second convex portion is greater than a radius of curvature of the third convex portion, and a central thickness of the first lens is greater than an edge thickness of the first lens.

8. The miniaturized optical device according to claim 6, wherein a diameter of the second concave portion is smaller than a diameter of the first planar portion, and a central thickness of the first lens is less than an edge thickness of the first lens.

9. An optical lens system, sequentially comprising along an optical axis from a light-receiving side to a light-emitting side:
a cemented lens; and
a light-receiving lens with negative refractive power, wherein the cemented lens includes at least two materials with different refractive indices and has positive refractive power.

10. The optical lens system according to claim 9, wherein the light-receiving lens and the cemented lens each have a light-receiving side surface facing the light-receiving side and a light-emitting side surface facing the light-emitting side, the light-receiving side surface of the light-receiving lens is provided with a first convex portion, the light-emitting side surface of the light-receiving lens is provided with a first concave portion adjacent to the optical axis, the light-receiving side surface of the cemented lens is provided with a first planar portion, and the light-emitting side surface of the cemented lens is provided with a second convex portion.

11. The optical lens system according to claim 10, wherein a diameter of the first concave portion is smaller than a diameter of the first convex portion, a curvature of the first concave portion is greater than a curvature of the first convex portion, and a central thickness of the light-receiving lens is greater than an edge thickness of the light-receiving lens.

12. The optical lens system according to claim 11, wherein the cemented lens sequentially includes a first lens and a second lens along the optical axis from the light-receiving side to the light-emitting side, the first lens has negative refractive power, and the second lens has positive refractive power.

13. The optical lens system according to claim 12, wherein a material forming the second lens has a refractive index lower than refractive indices of a material forming the first lens and a material forming the light-receiving lens.

14. The optical lens system according to claim 13, wherein the first lens and the second lens each have a light-receiving side surface facing the light-receiving side and a light-emitting side surface facing the light-emitting side, the light-receiving side surface of the first lens is provided with the first planar portion, a light-emitting side surface of the first lens is provided with a second concave portion, the light-receiving side surface of the second lens is provided with a third convex portion complementary to the second concave portion, and the light-emitting side surface of the second lens is provided with the second convex portion.

15. The optical lens system according to claim 14, wherein a diameter of the second convex portion is equal to a diameter of the third convex portion, a radius of curvature of the second convex portion is greater than a radius of curvature of the third convex portion, and a central thickness of the first lens is greater than an edge thickness of the first lens.

16. A miniaturized optical device, comprising:
a liquid crystal on silicon (LCOS) module configured to generate a primary incident light; and
an optical lens group having a folded optical path architecture, wherein the optical lens group is used to focus the primary incident light to produce an outgoing light,
wherein the optical lens group sequentially includes a first lens, a second lens, and a third lens from a light-receiving side to a light-emitting side.

17. The miniaturized optical device according to claim 16, wherein the LCOS module is a reflective LCOS module, including:
a light source providing an initial incident light;
a polarization element configured to receive the initial incident light and generate a first incident light with a first polarization direction;
a beam splitter receiving the first incident light from the polarization element and generating a first reflected light along a first optical path; and
an LCOS panel configured to, upon receiving the first reflected light with a first polarization direction, generate a second incident light with a second polarization direction along the second optical path and passing through the beam splitter.

18. The miniaturized optical device according to claim 17, wherein the first lens is an aspheric lens, the second lens and the third lens are spherical lenses, the first lens has positive refractive power, and the second lens and the third lens have negative refractive power.

19. The miniaturized optical device according to claim 18, wherein the second lens and the third lens each have a light-receiving side surface facing the light-receiving side and a light-emitting side surface facing the light-emitting side, the light-receiving side surface of the second lens is provided with a first phase-delayed element and a third convex portion, the light-emitting side surface of the second lens is provided with a first concave portion, and the light-receiving side surface of the third lens is provided with a second phase-delayed element.

20. The miniaturized optical device according to claim 19, wherein the light source is a light-emitting diode (LED) light source, and after the primary incident light passes through the first phase-delayed element to acquire a first delayed phase, the primary incident light undergoes a first reflection at the second phase-delayed element, returns to the first phase-delayed element for a second reflection, and then passes through the third lens to form the outgoing light.
